(19) United States
(12) Patent Application Publication
(10) Pub. No.: US 2013/0230621 A1
(43) Pub. Date: Sep. 5, 2013

(54) ROYAL JELLY SOLUTION AND METHOD FOR PRODUCING SAME

(71) Applicants: Wei-Lin Shao, Taichung (TW); Meng-Hseh Amanda Lin, Taichung (TW)

(72) Inventors: Wei-Lin Shao, Taichung (TW); Meng-Hseh Amanda Lin, Taichung (TW)

(73) Assignee: Vitalon Foods Co., Ltd., Taichung (TW)

(21) Appl. No.: 13/570,143

(22) Filed: Aug. 8, 2012

(30) Foreign Application Priority Data
Mar. 3, 2012 (TW) 101107190

(51) Int. Cl. A23L 1/076; A23J 3/34

(52) U.S. Cl. 426/7; 426/657

(57) ABSTRACT

A method for producing a royal jelly solution, comprising subjecting an aqueous royal jelly suspension to an enzymatic reaction catalyzed by an enzyme having cysteine protease activity at 20° C.˜70° C.

### CROSS-REFERENCE TO RELATED APPLICATION

This application claims priority of Taiwanese application no. 101107190, filed on Mar. 3, 2012.

### BACKGROUND OF THE INVENTION

1. Field of the Invention

This invention relates to a royal jelly solution and a method for producing the same and, more particularly, to a biotechnological method for producing a royal jelly solution in an opaque cream form by treating natural royal jelly with an enzyme, as well as the royal jelly solution produced thereby which presents in a stable opal opaque suspension form.

2. Description of the Related Art

Royal jelly is a yellowish-white, sticky, paste-like substance secreted from the hypopharynx glands of worker bees. It is reported that the larvae fed with royal jelly throughout their development stage will mature to be queen bees in only sixteen days and have a lifespan up to 5˜6 years. Therefore, royal jelly is believed to be beneficial in promoting longevity.

Fresh royal jelly usually presents in the form of a milky-white or pale-yellowish, paste-like semi-fluid. It is partially soluble in water and alcohol, can easily generate white precipitation and would spontaneously separate into layers if allowed to stand for a period of time. Fresh royal jelly has an average water content of 60˜70% and contains 9˜18% proteins, 7˜16% carbohydrates and 3˜8% lipids. Other components contained therein include free amino acids, vitamins (such as biotin, folic acid, inositol, niacin, pantothenic acid, and vitamins B₁, B₂ and E), minerals, peptides, fatty acids and bioactive compounds potentially beneficial to human health, such as 10-hydroxy-2-decenoic acid (abbreviated 10-HDA) and major royal jelly proteins (MRJPs). As such, royal jelly is often used as a natural nutrient supplement. Taiwanese Patent Publication No. 200526193 discloses utilization of royal jelly in an anti-aging composition. Taiwanese Patent No. 1340651 further teaches that the production of collagens can be facilitated by royal jelly.

While natural royal jelly is orally administerable, it is often rejected by people due to its spicy and sour taste and sticky texture, causing discomfort to throat. Furthermore, natural royal jelly requires storage under chilled or frozen conditions, as the proteins and enzymes contained therein are sensitive to temperature and tend to result in undesired brown discoloration at an elevated temperature. Therefore, natural royal jelly has long been known to have drawbacks in storability and taste. In order to overcome the drawbacks in storability, efforts have been made by the manufacturers to develop capsules or tablets filled with royal jelly in powder form. Chinese Patent Nos. CN100421578 and CN101223946, Chinese Patent Publication No. CN1076362A and Japanese Laid-open Patent Publication No. H5˜9125 disclose methods for producing royal jelly-containing beverages, which involve improving the storability of royal jelly solutions by blending them with significant amounts of carbohydrates and gums or by drying them into powder. These methods, however, have a noticeable limitation in that the beverages thus produced can only contain an unsatisfactory amount of natural royal jelly and, therefore, have limited nutrition value. There is a need for new technology for enhancing the amount of royal jelly added into beverages.

Because of its unique rheological property, royal jelly is prone to demonstrate pseudo-plastic behavior at a temperature above 25° C., causing difficulty in quality control during processing and storage. CN1076362A and JP5˜320060 teach removal of non-dissolvable components responsible for the pseudo-plastic property of royal jelly by dissolving royal jelly in water, removing water-insoluble sediments from the aqueous royal jelly solution via centrifugation, extracting the sediments with alcohol or acetone, centrifuging or filtering the resultant suspension after application of heat and adjustment of pH value to harvest an extract containing bioactive substances, and then adding the extract back to the aqueous royal jelly solution depleted of sediments. However, such treatment would easily discard certain alcohol-insoluble bioactive substances and fails to preserve a complete profile of bioactive substances derived from natural royal jelly. Moreover, the solvent used as the extracting agent for recovering bioactive substances from the sedimentation would remain in trace amounts in finished products and may potentially endanger consumers' health. Japanese Laid-open Patent Publication Nos. H1˜215268 and 2008˜118869 disclose addition of preservatives into aqueous solutions of royal jelly to prolong the shelf life. Preservatives, however, may give rise to certain health problems.

In addition, Taiwanese Patent No. 062795 and Japanese Patent Application No. H2-333641 disclose the treatment of royal jelly with proteolytic enzymes, i.e. pepsin and pancreatin, to improve the proteolytic degree, recovery rate and storability of royal jelly, thereby providing a transparent, clear royal jelly solution. However, the methods disclosed therein involve contacting two or more proteolytic enzymes with a pH-adjusted royal jelly solution, and the resultant solution contains a significant amount of insoluble protein precipitation and is prone to separation into layers. The plethora of protein precipitation present in the products may shorten the shelf life and make customers distrust the quality of the products due to their cloudy appearance. In order to obtain a clear royal jelly solution free of visible precipitation which normally contains insoluble protein, the process of centrifugal filtration or membrane filtration is often used to remove the precipitation. It is imperative that some unique bioactive substances and non-soluble proteins derived from natural royal jelly will also be removed and discarded after the centrifugation and filtration. As such, the royal jelly products produced by the conventional methods fail to provide a complete profile of bioactive substances and proteins derived from natural royal jelly and have limited nutrition value. Further, the methods disclosed in these patent publications involve treating royal jelly solutions with two or more enzymes derived from mammalian sources to enhance the recovery rate and controlling the added amount of natural royal jelly to avoid undesired turbidity, precipitation and flocculation. This fact, taken together with the fact that an additional filtration process is used to remove precipitation, makes the processes cost-ineffective and economically less attractive. In addition, the products manufactured by the traditional methods can only be added with limited amounts of natural royal jelly; otherwise, haziness or flocculation will occur to inhibit the formation of a stable suspension due to the presence of excessive amounts of natural royal jelly. Therefore, traditional royal jelly beverages usually have limited nutrition value due to discharge of insoluble protein.

Accordingly, a royal jelly solution with improved stability and nutritional value has to be developed in response to the needs of consumer and market. There is also a need for an improved method for producing a royal jelly solution, in which the waste of royal jelly material is reduced to a minimum.

### SUMMARY OF THE INVENTION

Therefore, an object of the present invention is to provide a method of treating royal jelly with an enzyme having a specific enzymatic activity to produce a royal jelly solution in a stable suspension form without generating a significant amount of precipitation or causing a separation between soluble and insoluble fractions. The royal jelly solution thus produced need not be subjected to further treatment for removing the undesired precipitation and, hence, substantially keeps all the nutrients derived from natural royal jelly.

According to one aspect of this invention, a method for producing a royal jelly solution is provided, which comprises subjecting an aqueous royal jelly suspension to an enzymatic reaction catalyzed by an enzyme having cysteine protease activity at 20° C.˜70° C. According to another aspect of this invention, a royal jelly solution made by the aforesaid method is obtained.

In general, royal jelly has: a protein content essentially composed of soluble and insoluble protein. Accordingly, the major royal jelly proteins (MRJPs) are present in an amount of 90% based on the total protein and play an important role it honeybee nutrition. It is Also found that MRJPs contain cysteine residues and are highly hydrophobic at their C-terminuses. The method for producing a royal jelly solution according to the invention is advantageous in utilizing an enzyme, i.e., a type of cysteine protease that involve a nucleophilic cysteine thiol in a catalytic dyad. This porteolytic effect allows protein degraded into small peptides or amino acid molecules, thereby making the ionizable amino and carboxylic groups exposed upon hydrolysis. By virtue of the enzymatic action of the cysteine protease on royal jelly proteins, the hydration of the protein molecules in the royal jelly solution is facilitated. Taking advantage of the protein degradation and the enzymatic action of the cysteine protease on the proteins, the protein molecules present in the royal jelly solution produced by the method of this invention will not easily precipitate and can be stably suspended in the solution for a long period of time. In contrast to the conventional methods, the invented method need not subject the royal jelly solution produced thereby to additional centrifugation or filtration to remove precipitation. Therefore, the invented method makes possible to maintain a complete profile of bioactive components and nutrients derived from natural royal jelly and provides a royal jelly solution having great nutrition value. Moreover, the royal jelly solution produced by the invented method can be surely maintained in a stable suspension form and is ready to serve as a beverage or a liquid stock, without the necessity of being further filtered, emulsified or homogenized. Compared to the prior art, the invention requires less processing steps and, thus, exhibits remarkably higher production efficiency and cost effectiveness.

The invention further provides a royal jelly solution, which is in a stable suspension form and is not prone to separation into layers.

The royal jelly solution disclosed herein is obtained by mixing a royal jelly raw material with water and subjecting the resultant aqueous royal jelly suspension to an enzymatic reaction catalyzed by an enzyme having cysteine protease activity. The royal jelly solution thus produced is present in a milky and stable suspension form and shows a peptide mass fingerprinting at 1214 m/z±0.5% and/or 2032 m/z±0.5%.

By virtue of contacting an enzyme having cysteine protease activity with the aqueous royal jelly suspension, the royal jelly solution produced has the advantages in exhibiting the peptide mass fingerprinting described above and being in the form of a milky, stable suspension free of visible precipitation and without the necessity of being subjected to additional centrifugation or filtration treatment. Since the invented royal jelly solution retains the whole essence of natural royal jelly, it has a greater nutrition value compared to its conventional counterparts and, therefore, can be directly made into a whole royal jelly beverage or a liquid preparation containing the complete profile of nutrients derived from natural royal jelly.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a flowchart illustrating the method for producing a royal jelly solution according to a preferred embodiment of the invention;

FIG. 2 is a photographic diagram showing the resultant appearances of the aqueous royal jelly suspensions after different treatments;

FIG. 3 is a bar diagram comparing the stability coefficients measured for the respective sample solutions produced through various enzymatic treatments;

FIG. 4 is a mass chromatogram showing the distribution of protein substances in the sample solution D1;

FIG. 5 is a mass chromatogram showing the distribution of protein substances in the sample solution D2;

FIG. 6 is a mass chromatogram showing the distribution of protein substances in the sample solution D3;

FIG. 7 is a mass chromatogram showing the distribution of protein substances in the sample solution D4;

FIG. 8 is a mass chromatogram showing the distribution of protein substances in the sample solution D5;

FIG. 9 is a mass chromatogram showing the distribution of protein substances in the sample solution D6; and

FIG. 10 is a mass chromatogram showing the distribution of protein substances in the sample solution D7.

### DETAILED DESCRIPTION OF TEE PREFERRED EMBODIMENTS

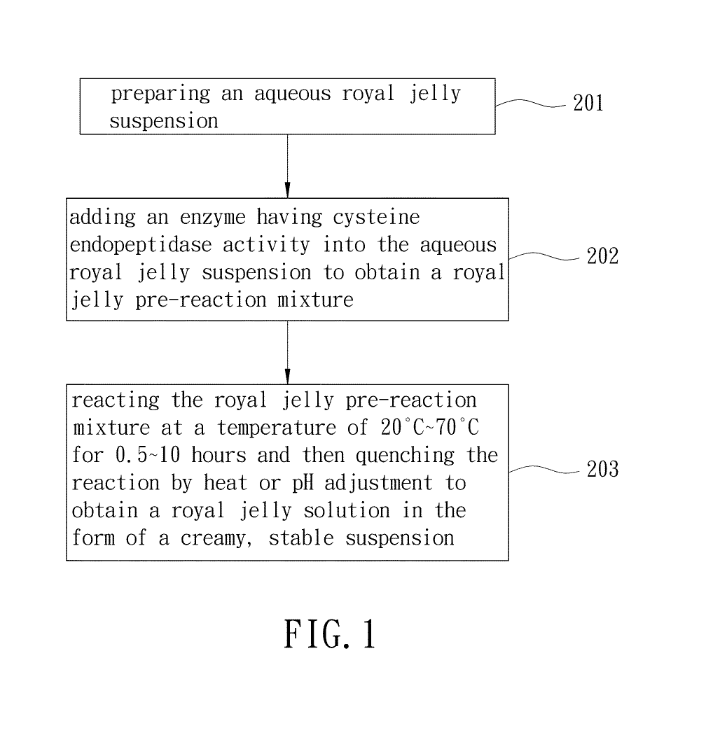

Referring to FIG. 1, a method for producing a royal jelly solution according to a preferred embodiment of the invention is illustrated, which comprises the following steps.

Step 201 comprises mixing a royal jelly raw material with water to obtain an aqueous royal jelly suspension. The royal jelly raw material is preferably selected from fresh natural royal jelly, frozen royal jelly material or lyophilized royal jelly material. The temperature of water used for preparing the aqueous royal jelly suspension is not critical but preferably ranges from 20° C. to 70° C., more preferably from 40° C. to 55° C., in a bid to achieve the mixing rapidly and prevent the royal jelly proteins from browning due to the elevated temperature. The concentration of the royal jelly rawmaterial in the aqueous royal jelly suspension can also be varied depending on the needs and preferably ranges from 0.1˜90 wt %, more preferably 2˜20 wt %.

Step 202 comprises adding an enzyme having cysteine protease activity into the aqueous royal jelly suspension to obtain a royal jelly pre-reaction mixture. According to this embodiment, the enzyme used herein is derived from a plant source or prepared by other methods and is selected from papain (such as that having an enzyme commission (EC) number of 3.4.22.2, 3.4.22.6 or 3.4.22.30), bromelain (such as that having an enzyme EC number of 3.4.22.32 or 3.4.22.33), ficain (such as that having an EC number of 3.4.22.3), and combinations thereof. In general, addition of anyone of the enzymes described above will achieve the effects intended by the invention, and the amount of the enzyme added into the aqueous royal jelly suspension is 0.01%˜90% based on the total weight of the aqueous royal jelly suspension. Preferably, the added amount of the enzyme is 0.05%˜10%, more preferably 0.1%˜5%, based on the total weight of the aqueous royal jelly suspension, in a bid to avoid flocculation due to the increase in enzyme level.

The enzyme commission number EC number) described above is a numerical classification system for enzymes, as proposed by Enzyme Commission based on the chemical reactions the enzymes catalyze. In terms of this nomenclature system, every enzyme known in the art is assigned a code consisting of the letters “EC” followed by four numbers representing a progressively finer classification of the enzyme. Each EC number denotes the classification and activity of a particular enzyme. For example, tripeptide aminopeptidases have the code “EC 3.4.11.4”, in which the component “EC3” is directed to hydrolases, the component “EC3.4” indicates hydrolases that act on peptide bonds, the component “EC3.4.11” is directed to hydrolases that cleave off the amino-terminal amino acid from a polypeptide, and the component “EC3.4.11.4” is directed to those that cleave off the amino-terminal end from a tripeptide.

Preferably, the enzyme having cysteine protease activity as used herein, such as papain, bromelain and ficain, exhibits neutral or acidic protease activity. In order to achieve the maximum reaction efficiency, the aqueous royal jelly suspension can be pre-adjusted to a pH value suitable for the enzyme to function. In usual cases, the aqueous royal jelly suspension prepared in Step 201 has already shown a pH of 3˜5, and the pH adjustment may be optionally omitted before the addition of enzyme. However, in the case where the pH value of the aqueous royal jelly suspension deviates from the desired range due to variation in sources or batches of the royal jelly raw material, or variation in the concentration of royal jelly raw material in the aqueous suspension, a pH adjustment may be carried out by addition of a pH regulator permitted by the food and drugs regulations into the aqueous royal jelly suspension. Examples of common pH regulators useful in the invention include, but are not limited to, citric acid, tartaric acid, malic acid, sodium hydroxide, sodium bicarbonate and lactic acid. Before addition of the enzyme, the aqueous royal jelly suspension may be adjusted to a pH of 2˜8 using the pH regulator. For achieving better reaction efficiency, the aqueous royal jelly suspension is preferably adjusted to a pH of 3˜6, more preferably to a pH of 3˜5.

Step 203 comprises reacting the royal jelly pre-react ion mixture at a temperature of 20° C.˜70° C. to obtain a royal jelly solution in the form of a stable, creamy, non-layered stable suspension substantially free of precipitation. In order to prevent the resultant royal jelly solution from brown discoloration and destabilization at the elevated temperature, the enzymatic reaction is preferably carried out at a temperature of 30˜60° C., more preferably 35˜55° C.

In order to achieve the desired reaction results while saving the reaction time to maintain the production efficiency, the royal jelly pre-reaction mixture, after the adjustment of the added amount of the enzyme and the reaction temperature, is allowed to react for a period of 0.6˜5 hours, preferably 0.7˜3 hours. When the intended reaction results or the arranged reaction time are achieved, the enzymatic reaction is quenched by a process selected from the group consisting of: heating the royal jelly pre-reaction mixture to a temperature of 70° C.˜110° C., and adjusting the royal jelly pre-reaction mixture to a pH of less than 2 or greater than 8. In other words, the enzyme is preferably deactivated by being placed at an elevated temperature or under an unsuitable pH environment. In the present embodiment, the enzymatic reaction is quenched by heating the pre-reaction mixture to an elevated temperature. After the completion of the enzymatic reaction catalyzed by papain or bromelain, the enzymatic activity is preferably quenched at a temperature between 80˜105° C., more preferably at a temperature between 90˜100° C. so as to prevent the resultant royal jelly solution from brown discoloration.

Preferably, the resultant royal jelly solution has a pH ranging from 3 to 5.

It should be noted that the royal jelly solution produced by the method of this invention, as analyzed by mass spectrometry, shows a peptide mass fingerprinting of 1214 m/z±0.5% and/or 2032 m/z±0.5%. In addition to showing at least one of the two principal peptide mass fingerprinting described above, the royal jelly solution may further exhibit one or more of mass spectrum peaks at the following m/z values: 1016 m/z±0.5%, 2016 m/z±0.5%, 3477 m/z±0.5%, 6030 m/z±0.5%, 6314 m/z±0.5%, 7413 m/z±0.5% and 8640 m/z±0.5%.

It is worthwhile to emphasize that the cysteine protease activity can be simply achieved in Step 202 by adding a single type of the enzymes described above into the aqueous royal jelly suspension, whereby a royal jelly solution is obtained in the form of a stable, opal-opaque, milky, non-layered suspension substantially free of precipitation, in the absence of any additive permitted for use in the food industry, including emulsifiers, stabilizers, excipients, anti-flocculants, solubilizers, stabilizing agents and thickeners. Since the royal jelly solution thus obtained is in a stable suspension form, it need not be subjected to additional clarification or filtration treatment and retains the whole essence of natural royal jelly. This advantage, taken together with the observation that the royal jelly solution exhibits an excellent stability after the enzymatic treatment and can be stored for a long period of time without addition of any stabilizer and preservative, makes the royal jelly solution have a great nutrition value due to the possession of a complete profile of nutrients derived from natural royal jelly and the absence of traditional food additives. Furthermore, compared to the conventional enzymatic treatment where the intended effects can only be achieved by adding two or more different kinds of proteolytic enzymes into an aqueous royal jelly suspension, the invention disclosed herein is apparently more cost-effective and environmentally friendly by using a single type of proteolytic enzyme derived from a less expensive plant source. Furthermore, less dosage of the proteolytic enzyme is required in this invention.

Nevertheless, the royal jelly solution disclosed herein is suitable for developing a broad variety of products. That is, the royal jelly solution can be formulated with various additives permitted by food or drugs regulations to form beverage products with different forms, oral intake properties, flavors and other properties. For example, the royal jelly solution can be added with the additives and materials permitted by food and drugs regulations, such as nutrition supplements, dietary supplement materials, dietary foodstuff, excipients, stabilizers, thickeners, anti-flocculants and so on. In one embodiment, the royal jelly solution may by way of example be formulated with or flavored by certain additives permitted by food and drugs regulations to produce a beverage product containing 40 grams of the royal jelly solution disclosed herein per 100 cc of the beverage product.

After subjecting to the enzyme treatment, the peptide bond is cleavage to expose ionizable amino and carboxylic groups, causing a change in surface charges and molecular conformations of the proteins and an increase in hydrophilic groups exposed on the protein surfaces. Upon being subjected to the enzymatic action, the protein molecules are highly hydrated and stably suspended in the royal jelly solution without precipitating or separating into layers. Moreover, the royal jelly solution obtained after the enzymatic treatment is still at an acidic pH lower than the isoelectric point (pI) of the proteins contained in the solution, whereby the overall hydration degree of the solution is increased. As such, after the enzymatic treatment using the enzyme having cysteine protease activity, all of the proteins present in the royal jelly solution, including the insoluble proteins that are initially prone to precipitation, can be stably suspended in the solution and are no longer prone to precipitation or separation into layers, taking advantage of the hydrophilic nature attributed to the hydrophilic amino acid residues and the difference between pH value of the solution and the pI of the proteins. As a result, the royal jelly solution disclosed herein need not be subjected to further separation treatment for removing the undesired precipitation, as the insoluble proteins prone to precipitation have been largely reduced. Compared to the conventional royal jelly solutions that have gone through precipitation removal treatment due to the presence of excessive sediments, the invented royal jelly solution retains the whole essence of natural royal jelly and has a greater nutrition value.

It is worthwhile, to emphasize that, in the case where the resultant royal jelly solution has a pH value higher than the pI of the proteins, a pH regulator permitted by the food and drugs regulations may be used to lower the pH of the solution to a level lower than the pI of the proteins, thereby maintaining the solution in a stable suspension form.

### Example 1

### Comparison of Invented Method with Conventional Enzymatic Treatment in Terms of Effects

Seven test tubes, designated as A1, A2, A3, A4, A5, A6 and A7 were provided, each being loaded with an aliquot of an aqueous royal jelly suspension in which royal jelly was included at a concentration of 5.8 wt %. The seven samples were subjected to the following treatments, respectively:

A1: Pepsin was added in an amount of 0 wt % based on the weight of the aqueous royal jelly suspension and allowed to react at 45° C. for 6 hours. Then, an acidic protease derived from Aspergillus oryzae) was added in an amount of 0.1 wt % based on the weight of the aqueous royal jelly suspension and allowed to react at 45° C. for additional 6 hours. The resultant solution was adjusted to pH 5.5 and subjected to heat at 80° C. for 10 minutes to quench the enzymatic action.

A2: The aqueous royal jelly suspension was adjusted to pH 8. Then, a neutral protease (Prolease, a protease from Bacillus subtilis) and trypsin were added in an amount of 0.05 wt % based on the weight of the aqueous royal jelly suspension and allowed to react at 45° C. for 6 hours. The resultant solution was adjusted to pH 5.5 and subjected to heat at 80° C. for 10 minutes to quench the enzymatic action.

A3: The suspension, having a pH of 4.0, was not added with any enzyme and kept at 55° C. The resultant solution was observed 3 hours later.

A4: Papain was added in an amount of 0.15 wt % based on the weight of the aqueous royal jelly suspension. Enzymatic reaction was carried out at 55° C. and pH 4.1. After 0.5 hour, the enzymatic reaction was thermally quenched at 95° C. for 5 minutes.

A5: Experiment was carried out under the same conditions as those for A4, except that the enzymatic reaction was thermally quenched after a 1-hour reaction period.

A6: Experiment was carried out under the same conditions as those for A4, except that the enzymatic reaction was thermally quenched after a 3-hour reaction period.

A7: Experiment was carried out under the same conditions as those for A4, except that the enzymatic reaction was thermally quenched after a 5-hour reaction period.

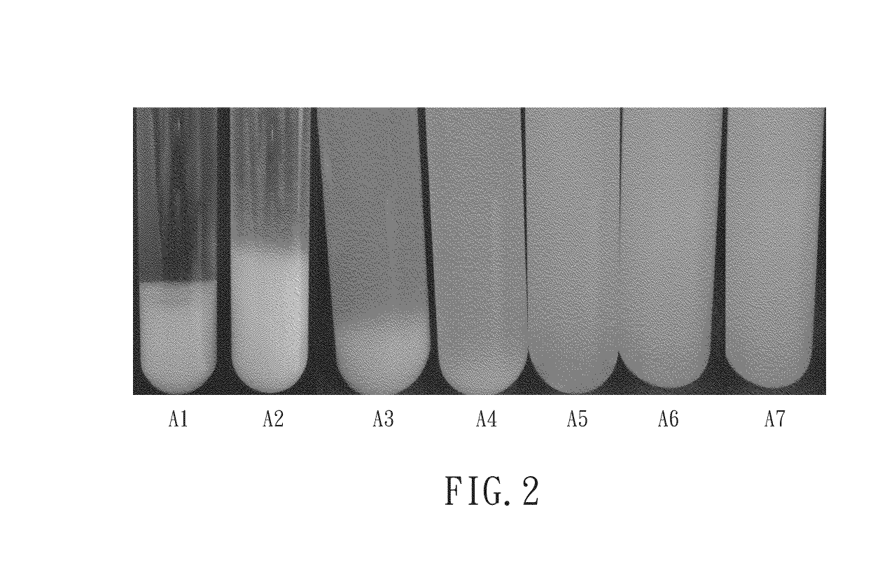

The results are shown in FIG. 2, where the appearances of the solutions contained in the test tubes A1˜A7 were observed and recorded after the enzymatic treatment. The solution in A1, as observed, was composed of a clear top layer and a bottom layer having significant precipitation. The solution in A2 included a clear top layer and an opaque, cloudy bottom layer containing sediments in opal color. In the A3 test tube, white sediments were observed at bottom, while the top layer of the solution appeared cloudy. The solution in A4, compared to that in A3, contained a considerably reduced amount of white sediments. However, the top layer of the A4 solution was still cloudy. The solutions in A5˜A7 appeared clear, and they neither undergo a separation into two phases nor contain visible precipitation. The results shown in FIG. 2 indicate that the royal jelly solutions produced by the method according to the invention, i.e., the solutions produced through the papain treatment in A4˜A7, were in a stable suspension form without undergoing a separation into layers. The fact that the solution in A4 contains a considerably less amount of sediments compared to the solution in A3 further evidences that the invented royal jelly solution has a reduced amount of insoluble proteins, by which the occurrence of the undesired precipitation and layering phenomenon is eliminated. The results also suggest that the drawbacks of precipitation and layering occurring in the solution can be eliminated by simply increasing the added amount of enzyme or prolonging the reaction time (as indicated by A5˜A7). In contrast to the royal jelly solutions prepared according to the invention which are in a stable, creamy suspension form, the royal jelly solutions produced by the conventional enzymatic treatment (i.e., the solutions in A1 and A2) still contain a significant amount of sediments, while having a clear top layer.

### Example 2

### Tests for Solution Stability, Stability Coefficient, Active Substances and Suspension Stability

Five samples of royal jelly solutions B1, B2, B3, B9 and B5 prepared by the method according to the invention were provided in comparison with the royal jelly sample solutions C1, C2, C3, C4 and C5 produced by the conventional methods, in terms of sedimentation rate, stability coefficient, 10-hydroxy-2-decenoic acid content and the stability thereof, and suspension stability. The sample solutions B1˜B5 and C1˜C5 were prepared according to the following processes, respectively:

Sample Solution B1:

100 grams of royal jelly was uniformly mixed with water at room temperature (around 25° C.) to reach a final weight of 1 kg, resulting in an aqueous suspension of 10 wt % royal jelly. The aqueous suspension was adjusted to pH 4 and then heated to 60° C. To the aqueous royal jelly suspension, 10 g papain (1% by weight of the aqueous royal jelly suspension) was added to obtain a royal jelly pre-reaction mixture. An enzymatic reaction catalyzed by papain was allowed to carry out at 60° C. for 3 hours and then quenched at 85° C. for 20 minutes to obtain a royal jelly solution.

Sample Solution B2:

205 g royal jelly was uniformly mixed with water at 45° C. to reach a final weight of 1 kg, resulting in an aqueous suspension of 20.5 wt % royal jelly. The aqueous suspension was adjusted to pH 4 by citric acid or sodium citrate. To the aqueous royal jelly suspension, 10 g bromelain (1% by weight of the aqueous royal jelly suspension) was added to obtain a royal jelly pre-reaction mixture. An enzymatic reaction catalyzed by bromelain was carried out at 55° C. for 1 hour and then quenched at 90° C. for 5 minutes to obtain a royal jelly solution.

Sample Solution B3:

400 g royal jelly was uniformly mixed with 1 kg warm water (50° C.) to obtain an aqueous royal jelly suspension. The aqueous suspension was adjusted to pH 4 and then heated to 50° C. To the aqueous royal jelly suspension, bromelain was added in an amount of 5 wt % based on the weight of the aqueous royal jelly suspension. Enzymatic reaction was carried out for 1 hour and then quenched at 80° C. for 5 minutes to obtain a royal jelly solution.

Sample Solution B4:

An aqueous suspension of 5.5 wt % royal jelly was prepared according to the process for preparing Sample solution B3 above and then heated to 60° C. To the aqueous royal jelly suspension, papain was added in an amount of 0.5% based on the weight of the aqueous royal jelly suspension. Enzymatic reaction was carried out at 60° C. for 50 minutes and then quenched at 90° C. for 10 minutes.

Sample Solution B5:

58 g royal jelly was formulated into an aqueous suspension of 5.8 wt % royal jelly and then heated to 55° C. To the aqueous royal jelly suspension, papain was added in an amount of 0.15% based on the weight of the aqueous royal jelly suspension. Enzymatic reaction was carried out at 55° C. for 45 minutes and then quenched at 95° C. for 5 minutes.

Sample Solution C1:

An aqueous suspension of 10 wt % royal jelly was prepared according to the process for preparing Sample solution 31 above and then heated to 60° C. Hydrolysis was allowed to carry out for 3 hours in the absence of an enzyme activity to give a milky royal jelly solution. The solution was subjected to filtration to remove precipitation and insolubles.

Sample Solution C2:

Royal jelly was formulated with water at 45° C. to produce an aqueous suspension of 20.5 wt % royal jelly. To the aqueous suspension, ethanol was added in an amount of 35% by weight of the aqueous suspension. Hydrolysis was allowed to carry out at 45° C. for 1 hour.

Sample Solution C3:

An aqueous suspension of 6 wt % royal jelly was prepared and adjusted to pH 4. The resultant aqueous suspension was incubated in water bath at 50° C. for 1.5 hours.

Sample Solution C4:

A 1 kg aqueous suspension of 10 wt % royal jelly was prepared and adjusted to pH 4 using a 20 wt % sodium hydroxide solution. To the aqueous suspension, 1 g pepsin was added, and the enzymatic reaction was carried out at 45° C. for 6 hours. Then, 1 g of an acidic protease derived from Aspergillus oryzae was added and the enzymatic reaction was carried out at 45° C. for additional 6 hours. The resultant solution was adjusted to pH 5.5 using a 20 wt % sodium hydroxide solution or a 10 wt % critic acid solution, and then subjected to heat at 80° C. for 10 minutes to deactivate the enzymes. The royal jelly solution thus produced, when not subjected to filtration, was composed of a clear top layer and a precipitated bottom layer.

Sample Solution C5:

A 1 kg aqueous suspension of 10 wt % royal jelly was prepared and adjusted to pH 8 using a 20 wt % sodium hydroxide solution. To the aqueous suspension, 0.5 g of a neutral protease (Prolease, a protease from Bacillus subtilis) and 0.5 g trypsin were added, and the enzymatic reaction was carried out at 45° C. for 6 hours. The resultant solution was adjusted to pH 5.5 using a 20 wt % sodium hydroxide solution or a 10 wt % critic acid solution, and then subjected to heat at 80° C. for 10 minutes to deactivate the enzymes. The royal jelly solution thus produced, when not subjected to filtration, was composed of a clear top layer and an opaque bottom layer in opal color.

### (1) Test for Sedimentation Rate, Evaluation of Stability and Sensory Evaluation of Astringent Sour Taste

The sedimentation rate of a given royal jelly solution represents the long-term stability of the solution. In the royal jelly solution, particles with larger sizes or greater weights will more easily sediment to the bottom of the test tube due to gravity. This measure was useful for describing the suspension stability of particles in the solution. In general, the lower the sedimentation rate, the better the stability of the solution. This test was used herein for measuring the respective sedimentation rates of the sample solutions B1˜B5 produced by the invented method and the sample solutions C1˜C5 prepared according to the conventional methods, in a bid to further assess the degrees of emulsification and particle suspension of the respective solutions. During the test, the sample solutions B1˜B5 and C1˜C5 were loaded into centrifuge tubes, respectively, and centrifuged at a temperature of less than 25° C. at 4000 rpm. for 10 minutes. The sedimentation rates for the respective sample solutions were calculated according to the equation (E1) below. The stability and astringent sour taste of the sample solutions were further evaluated, in which the stability evaluation was carried out by observing the stability of the respective samples solutions B1˜B5 and C1˜C5 after a one-month standing in terms of the degrees of sedimentation and flocculation, and the astringent sour taste of the respective samples was scored by specialists.

$$Sedimentation Rate = \frac{Weight before centrifuge ( g ) - Weight after centrifuge ( g )}{Weight before centrifuge ( g )} \qquad ( E1 )$$

The results are shown in Table 1 below.

TABLE 1

| Sample | Sedimentation | Beverage | Astringent |
|---|---|---|---|
| solution | Rate | Stability* | Sour Taste** |
| B1 | <2% | ⊚ | + |
| B2 | 2.2% | ◯ | + |
| B3 | <2% | ⊚ | ++ |
| B4 | <2% | ⊚ | + |
| B5 | <2% | ⊚ | + |
| C1 | 30% | Δ | ++ |
| C2 | 10% | Δ | +++ |
| C3 | 7% | Δ | + |
| C4 | 23% | Δ | ++ |
| C5 | 26% | Δ | + |

*Stability evaluation: ⊚ stable, with very little precipitation; ◯ relatively unstable, with some precipitation; and Δ highly unstable, with significant precipitation.
**Astringent sour taste: +++ strong; ++ fair; + weak.

The results shown in Table 1 indicate that the royal jelly solutions produced under the enzymatic action of papain or bromelain (i.e., the sample solutions B1˜B5) exhibited considerably lower sedimentation rates as compared to the sample solutions C1˜C5 which were processed by the enzymes other than those disclosed herein. The sample solutions B1˜B5 remained almost free of precipitation and flocculation for a month, suggesting that they were highly stable. Compared to the sample solutions C1˜C5, the sample solutions B1˜B5 seem less possible to generate precipitation and flocculation when being made into royal jelly beverages. As regards the flavor, the unique astringent sour taste of the royal jelly solutions produced through the enzymatic reaction catalyzed by the enzymes disclosed herein (i.e., the sample solutions. B1˜B5) was considerably lighter than that of the sample solutions C1˜C5, indicating that the royal jelly solutions produced by the invented method are also improved in terms of flavor. In overall terms, the royal jelly solutions produced by the invented method were shown superior to the royal jelly solutions produced by the conventional methods, especially in view of the higher beverage stability and the weaker astringent sour taste of the sample solutions B1˜B5 disclosed herein.

### (2) Stability Coefficient

This measure was primarily used to describe the stability of a given royal jelly solution under an acidic environment. That is, the higher the stability coefficient, the better the stability of the solution. During the test, the sample solutions B1˜B5 and C1˜C5 were centrifuged at 3500 rpm. for 15 minutes. Stability coefficients for the respective sample solutions were obtained by measurement of absorbance at 660 nm using a spectrophotometer (PARADISM™ Detection Platform purchased from Beckman Coulter) and by calculation according to the equation below:

$$Stability Coefficient ( R ) = \frac{Absorbance before centrifuge ( A )}{Absorbance after centrifuge ( A )} \times 100 \%$$

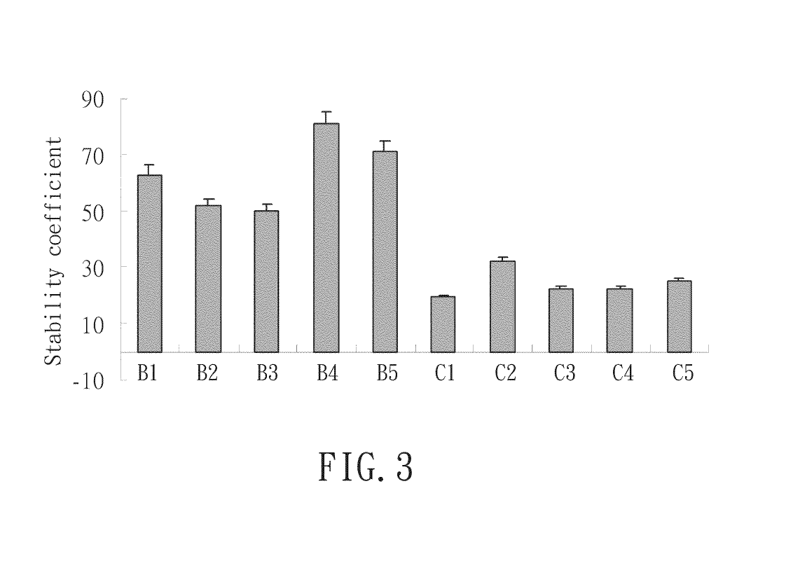

The results shown in FIG. 3 indicate that the royal jelly solutions produced through the enzymatic reaction of this invention (i.e., the sample solutions B1˜B5) were superior to the royal jelly solutions processed by the enzymes other than those of this invention (i.e., the sample solutions C1˜C5), in view of the higher stability coefficients of the sample solutions B1˜B5 disclosed herein. The sample solution B4 has the highest stability coefficient, while the sample solution B5 holds the second highest one. These results reached the conclusion that the royal jelly solutions produced by the invented method have improved stability attributed to the enzymatic reaction catalyzed by the enzymes disclosed herein.

(3) 10-Hydroxy-2-decenoic acid Content and Stability Thereof

10-Hydroxy-2-decenoic acid (10-HDA) is a bioactive substance present in royal jelly and is known to benefit human health and, therefore, is regarded as an important index for assessment of the nutrition value of a given royal jelly solution. The 10-HDA contents in the respective sample solutions B1˜B5 and C1˜C5 were measured and the stability thereof were further evaluated by performing high performance liquid chromatography on a C₁₈ chromatographic column having an inner diameter of 4.6 mm and a length of 250 mm, using an Agilent 1200 series TO HPLC system (Agilent Technologies Inc.). Absorbance was measured at a wavelength of 210 nm and the 10-HDA contents were determined by comparing the measured values to a standard curve.

TABLE 2

| | 10-HDA Content | |
|---|---|---|
| Sample | (mg/g) | 10-HDA Stability* |
| Natural Royal jelly | 6.2 | |
| Sample Solution B1 | 6.2 | +++ |
| Sample Solution B2 | 6.0 | ++ |
| Sample Solution B3 | 6.2 | +++ |
| Sample Solution B4 | 6.2 | +++ |
| Sample Solution B5 | 6.2 | +++ |
| Sample Solution C1 | 4.9 | + |
| Sample Solution C2 | 4.8 | + |
| Sample Solution C3 | 5.5 | + |
| Sample Solution C4 | 5.9 | ++ |
| Sample Solution C5 | 6.0 | ++ |

*Stability was evaluated in terms of the decrease in 10-HDA content, wherein +++ denotes a substantially unchanged 10-HDA content after one month storage; ++ denotes a decrease of less than 1% (<1%) after one month storage; + denotes a decrease of more than 1% (>1%) after one month storage.

The results shown in Table 2 indicate that the royal jelly solutions produced by the invented method (i.e., the sample solutions B1˜B5) had 10-HDA contents substantially comparable to that of natural royal jelly after one month storage at room temperature. The results show that the active substance 10-HDA was effectively retained in the royal jelly solutions produced by the invented method with higher stability compared to the royal jelly solutions prepared by the methods other than the method disclosed herein. In contrast, the initial 10-HDA contents in the sample solutions C1˜C5 were slightly lower than that in natural royal jelly, and such 10-HDA contents tended to decrease as observed one month later. All of these results point toward a conclusion that the royal jelly solution prepared by the invented method has a stable 10-HDA content and an excellent nutrition quality.

### (4) Particle Suspension Stability

The sample solutions B1˜B5 and C1˜C5 were tested for the levels of particles suspended in the solutions. This test was carried out using a turbidity meter (HACH 2100Q) that measures turbidity as a function of the light deflected from the solutions. A solution will have a high turbidity value, represented by nephelometric turbidity unit (NTU), if lots of small particles are suspended in the solution to scatter an incoming light beam. The royal jelly sample solutions C4 and C5 were filtered to remove sediments before subjected to the turbidity measurement.

TABLE 3

| Sample | Turbidity (NTU) | Stability* |
|---|---|---|
| Sample solution B1 | 755.0 | +++ |
| Sample solution B2 | 752.1 | ++ |
| Sample solution B3 | 755.3 | +++ |
| Sample solution B4 | 755.1 | +++ |
| Sample solution B5 | 753.0 | +++ |
| Sample solution C1 | 116 | + |
| Sample solution C2 | 85 | + |
| Sample solution C3 | 109 | + |
| Sample solution C4 | 29.3 | + |
| Sample solution C5 | 30.1 | + |

*Stability was evaluated in terms of the decrease in turbidity, wherein +++ denotes a substantially unchanged turbidity after one month storage; ++ denotes a turbidity change of less than 1% (<1%) after one month storage; + denotes a turbidity change of more than 1% (>1%) after one month storage.

The results shown in Table 3 show that the turbidity values of the royal jelly solutions produced by the invented method (i.e., the sample solutions B1˜B5) remained substantially unchanged after one month storage at room temperature, indicating that the sample solutions B1˜B5 produced by the method of this invention can be maintained in a stable suspension form for a long period of time without occurrence of the undesired precipitation and layering phenomenon. In comparison, the royal jelly sample solutions C1˜C5 were less turbid and relatively clear initially due to the occurrence of the precipitation and layering phenomenon. After one month storage at room temperature, however, the turbidity of the sample solutions C1˜C5 got higher somehow, suggesting that sediments were continuously generated in the top clear layers of the sample solutions C1˜C5 during the storage, causing white cloudiness and an increase in turbidity. In other words, some substances in the sample solutions C1˜C5 failed to be stably suspended in the solutions, from which it can reasonably be inferred that some substances in the sample solutions C1˜C5 tend to be very labile. In conclusion, the protein molecules present in the royal jelly solutions produced by the invented method can be stably suspended in the solutions for a long period of time. By taking advantage of these characteristics, the invention makes possible to produce a royal jelly solution that is ready to be made into a beverage or a liquid preparation containing the complete profile of protein substances derived from natural royal jelly, without the necessity of subjecting the solution to further filtration or centrifugation to remove precipitation.

### Example 3

### Protein Identification

The masses of the proteins or protein fragments in royal jelly sample solutions are identified by peptide mass fingerprinting technology using a matrix-assisted laser desorption ionization time-of-flight mass spectrometer (MALFI-TOF-MASS; Applied Biosystems Voyager-DE™ PR; Operation Mode: linear, Polarity: positive, Voltage: 2000V, Mass Range: 500˜45000Da). An enzyme-untreated royal jelly sample solution D1, as well as royal jelly sample solutions D2˜D7 produced under different enzymatic reaction conditions, were characterized to identify proteins contained in the respective solutions. The sample solutions D1˜D7 were prepared according to the following processes, respectively:

Sample Solution D1:

An aqueous suspension of 6 wt % royal jelly was prepared without being subjected to any enzymatic treatment.

Sample Solution D2:

An aqueous suspension of 6 wt % royal jelly was prepared, to which papain was added in an amount of 0.1 wt % based on the weight of the aqueous royal jelly suspension. Enzymatic reaction was allowed to carry out at a temperature of 50˜55° C. for 30 minutes.

Sample Solution D3:

An aqueous suspension of 6 wt % royal jelly was prepared, to which papain was added in an amount of 0.1 wt % based on the weight of the aqueous royal jelly suspension. Enzymatic reaction was carried out at a temperature of 50˜55° C. for 3 hours.

Sample Solution D4:

An aqueous suspension of 6 wt % royal jelly was prepared, to which papain was added in an amount of 1 wt % based on the weight of the aqueous royal jelly suspension. Enzymatic reaction was carried out at a temperature of 5055° C. for 30 minutes.

Sample Solution D5:

An aqueous suspension of 6 wt % royal jelly was prepared, to which papain was added in an amount of 1 wt % based on the weight of the aqueous royal jelly suspension. Enzymatic reaction was carried out at a temperature of 50˜55° C. for 3 hours.

Sample Solution D6:

An aqueous suspension of 6 wt % royal jelly was prepared, to which bromelain was added in an amount of 0.1 wt % based on the weight of the aqueous royal jelly suspension. Enzymatic reaction was carried out at a temperature of 50˜55° C. for 1 hour.

Sample Solution D7:

An aqueous suspension of 6 wt % royal jelly was prepared, to which bromelain was added in an amount of 1 wt % based on the weight of the aqueous royal jelly suspension. Enzymatic reaction was carried out at a temperature of 50˜55° C. for 1 hour.

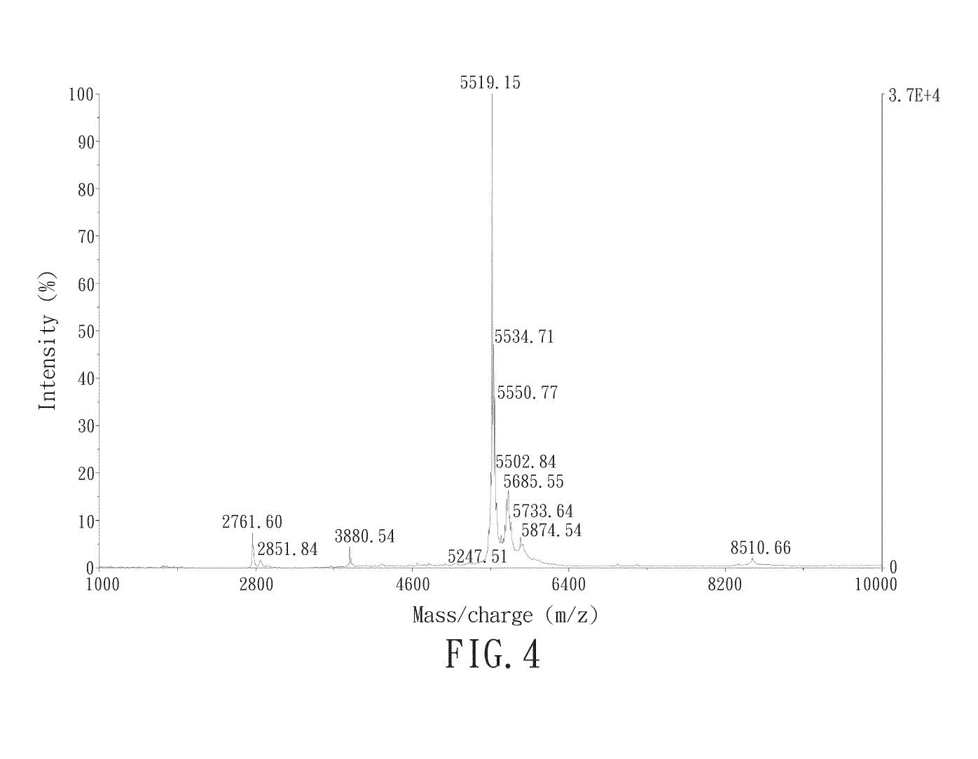

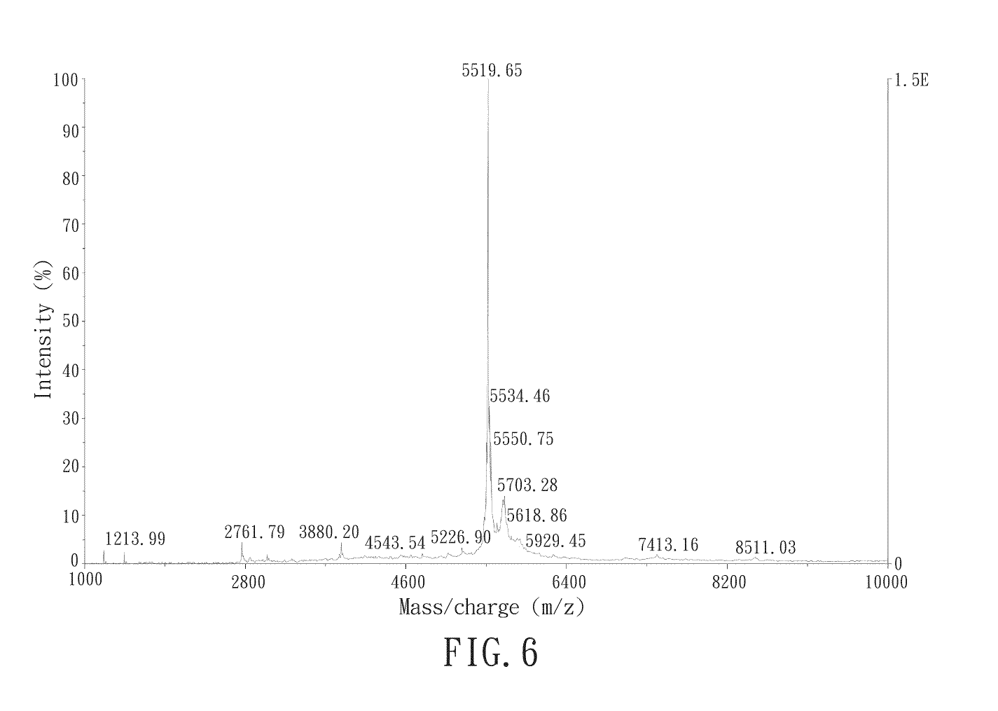

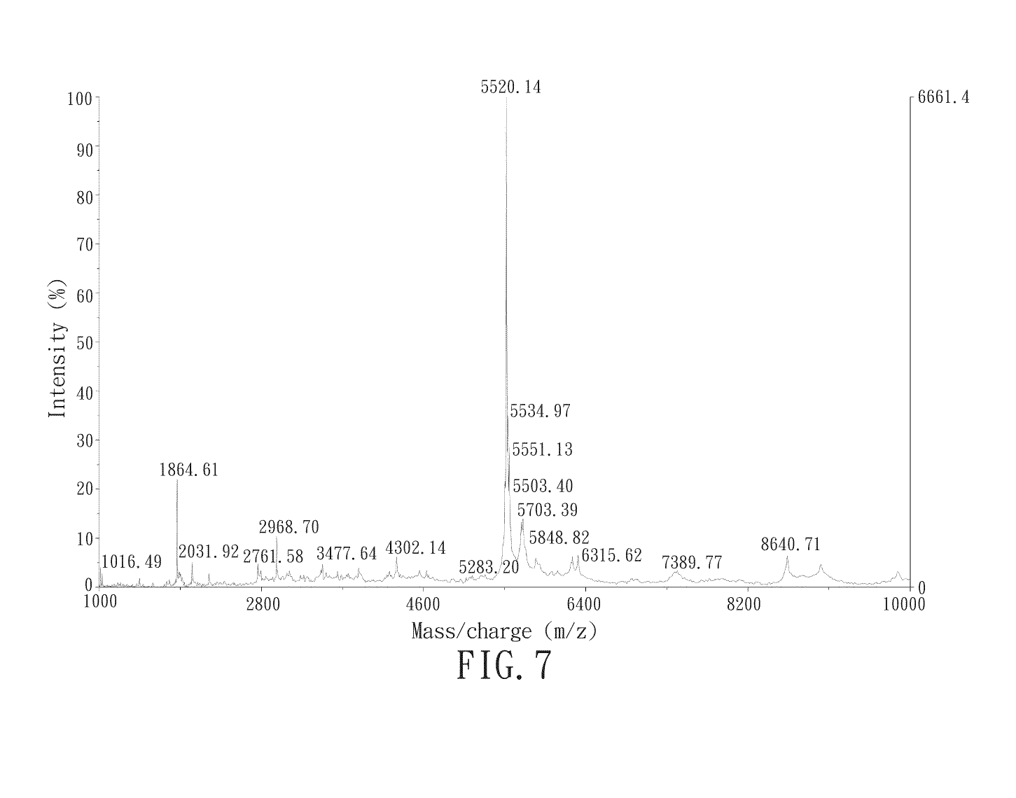

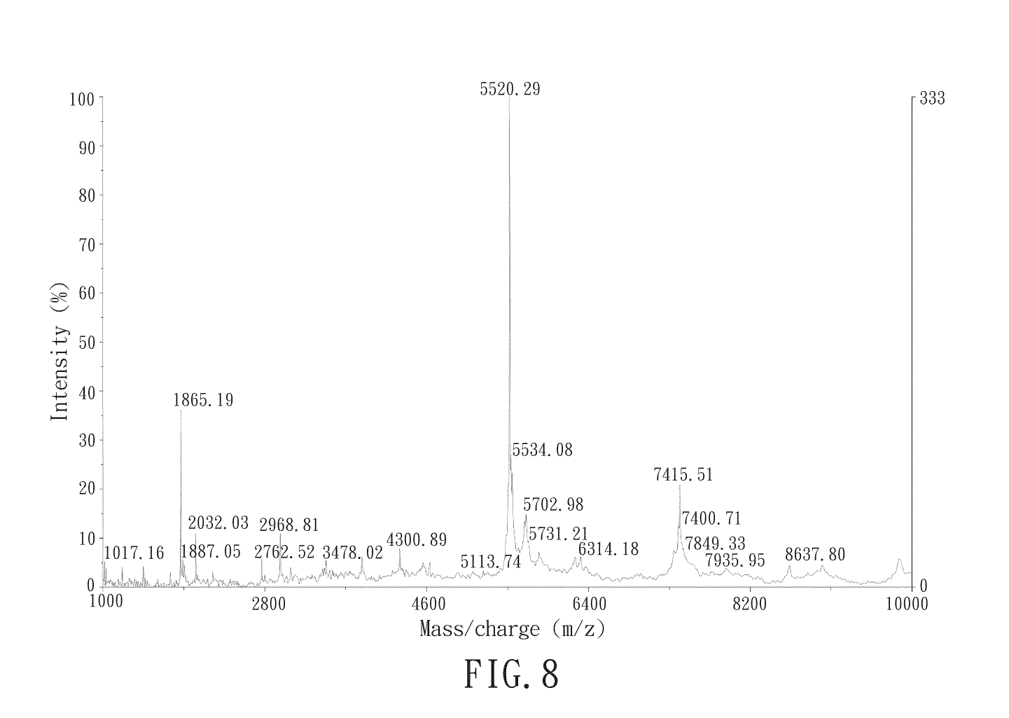

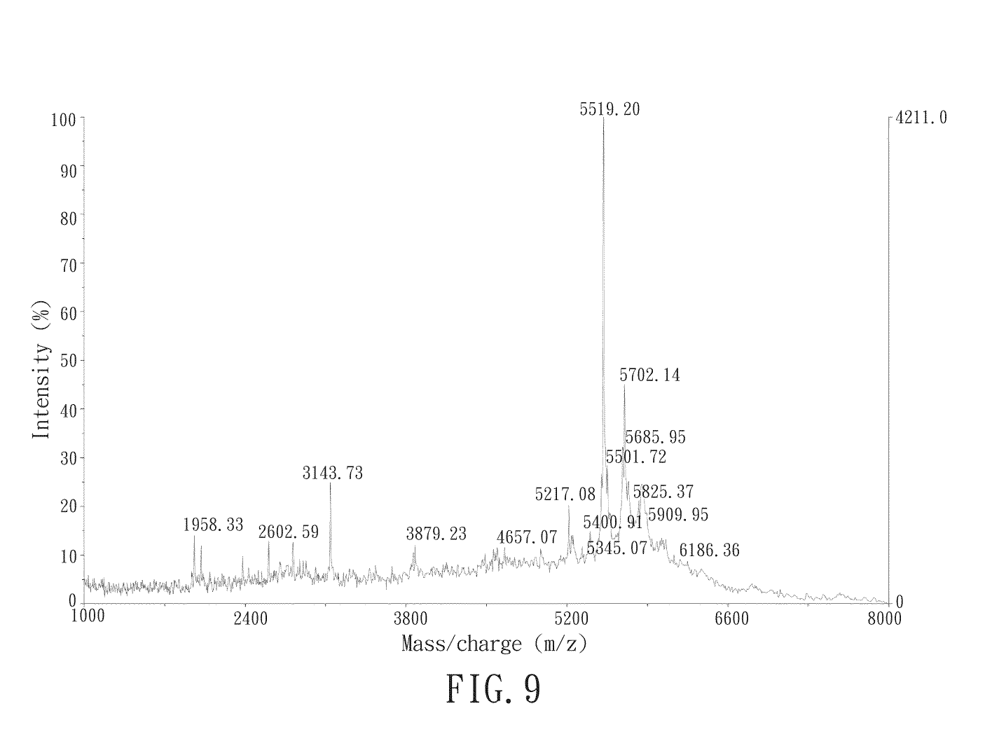

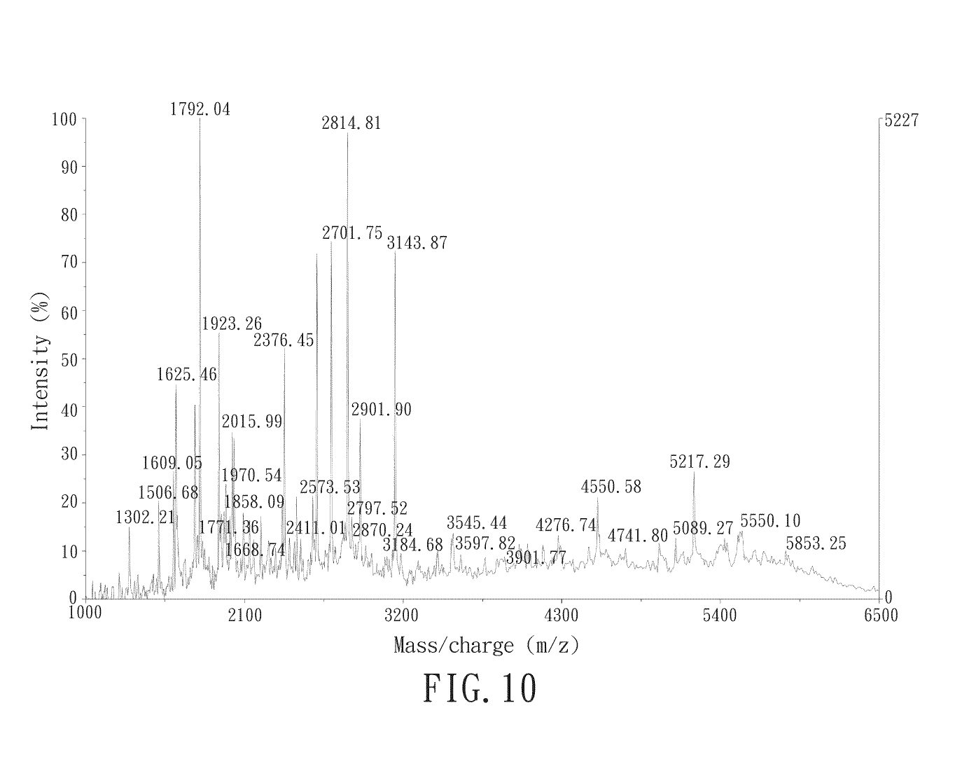

The sample solutions D1˜D7 described above were desalted and then analyzed by the peptide mass fingerprinting technology using a MALDI-TOF MS (Applied Biosystems, Voyager-DE™ PR), thereby identifying characteristic mass/charge of the respective solutions. The characteristic mass spectra for D1 to D7 are respectively shown in FIGS. 4 to 10.

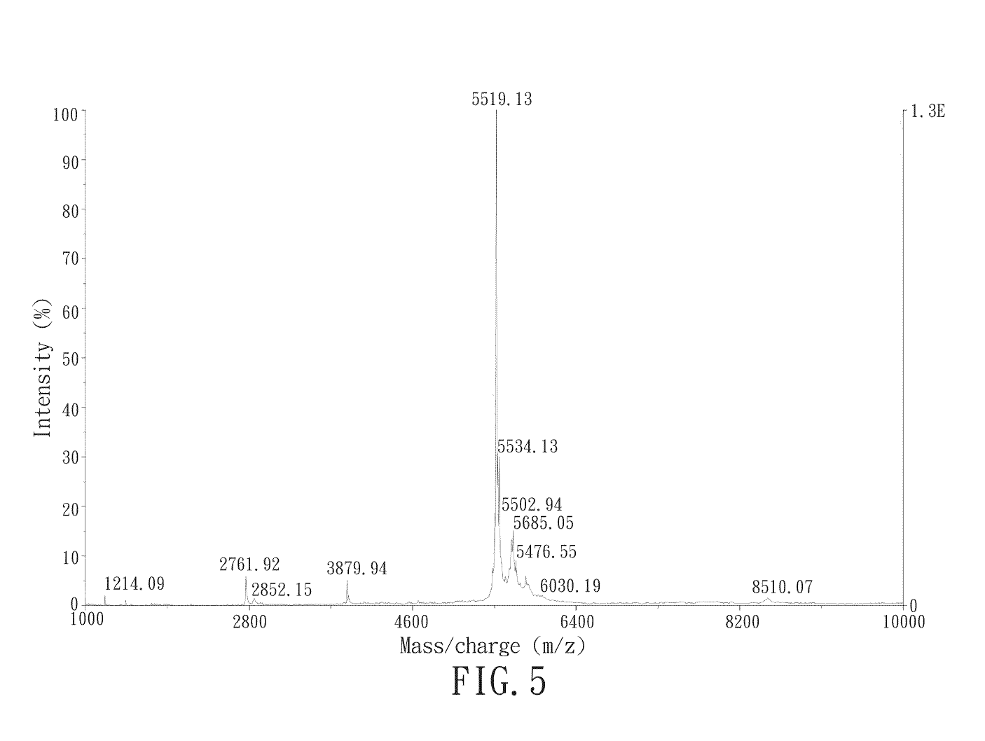

By comparison of the characteristic mass spectra shown in FIG. 4 and FIGS. 5˜10, the royal jelly solutions treated with enzyme appeared significantly different from the enzyme-untreated royal jelly solution in terms of the mass spectrum protein peaks located within the ranges of 1000˜1900 m/z, 2000˜2900 m/z, 3100˜3600 m/z, 4200˜4500 m/z, 6000˜6400 m/z, suggesting that the peak signals located within these ranges were directed to the masses of the protein molecules generated by enzymatic cleavage. By virtue of the peptide mass fingerprinting technology, the royal jelly solutions produced by the invented method were characterized by having peptide mass fingerprinting at 1016 m/z±0.5%, 1214 m/z±0.5%, 2016 m/z±0.5%, 2032 m/z±0.5%, 3477 m/z±0.5%, 6030±0.5% m/z, 6314 m/z±0.5%, 7413±0.5% or 8640 m/z±0.5%. That is, the royal jelly solutions produced through the enzymatic treatment disclosed herein would have contained the protein molecules identified by the peptide mass fingerprinting described above.

According to the foregoing descriptions, the method for producing a royal jelly solution as disclosed herein can surely achieve the intended objects by providing the effects and advantages described below.

1. As clearly demonstrated in the Examples above, unlike the conventional techniques (such as those disclosed in Taiwanese Patent No. 208043 and Japanese Patent Application No. H2-333641) which require two or more different kinds of enzymes to achieve the intended results, the invention disclosed herein involves using only one enzyme to successfully convert natural royal jelly into a royal jelly solution present in a stable suspension form with high component stability. The royal jelly solution thus produced has a stable quality and, therefore, is suitable for being made into royal jelly products containing the whole essence of natural royal jelly. Since the invention involves using a single type of enzyme and need not carry out an additional filtration or centrifugation process, it has the advantages of having a reduced cost of raw materials and a simplified operation procedure. These advantages, taken together with the stable quality of the products thus produced, make the invention disclosed herein highly cost-effective and environmentally friendly.

2. The royal jelly solutions produced by the invented method are not only suitable for being made into the products that contain the whole essence of natural royal jelly, but also perform high stability in terms of solution stability, stability coefficient, content and stability of an active substance and long-term suspension stability. All of these indicate that the royal jelly solution disclosed herein does not only provide a complete profile of nutrients but also exhibits stable product quality.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method for producing a royal jelly solution, comprising subjecting an aqueous royal jelly suspension to an enzymatic reaction catalyzed by an enzyme having cysteine protease activity at 20° C.˜70° C.

2. The method for producing a royal jelly solution of claim 1, wherein the enzyme is selected from the group consisting of papain, bromelain, ficain and combinations thereof.

3. The method for producing a royal jelly solution of claim 2, wherein the enzyme is added in an amount of 0.01%˜90 wt % based on the weight of the aqueous royal jelly suspension.

4. The method for producing a royal jelly solution of claim 1, further comprising, before subjecting the enzymatic reaction, the step of adjusting the aqueous royal jelly suspension to a pH of 2˜8.

5. The method for producing a royal jelly solution of claim 4, further comprising, before adjusting the pH of the aqueous royal jelly suspension, the step of mixing a royal jelly raw material with water to obtain the aqueous royal jelly suspension containing 0.1˜40 wt % of the royal jelly raw material.

6. The method for producing a royal jelly solution of claim 1, further comprising, after subjecting the enzymatic reaction, the step of quenching the enzymatic reaction at 70° C.˜110° C. or under a pH of less than 2 or greater than 8.

7. A royal jelly solution obtained by the method of claim 1.

8. The royal jelly solution of claim 7, wherein said royal jelly solution is in a milky, stable suspension form and has a peptide mass fingerprinting at 1214 m/z±0.5% and/or 2032 m/z±0.5%.

9. The royal jelly solution of claim 8, further comprising a peptide mass fingerprinting at 1016 m/z±0.5%, 2016 m/z±0.5% 3477 m/z±0.5%, 6030 m/z±0.5%, 6314 m/z±0.5%, 7413 m/z±0.5% or 8640 m/z±0.5%.

10. The royal jelly solution of claim 7, wherein said royal jelly solution has a pH of 3˜5.
